(19) United States
(12) Patent Application Publication
(10) Pub. No.: US 2016/0055591 A1
(43) Pub. Date: Feb. 25, 2016

(54) Automatic Crediting for Long Term Care Insurance Based on Interest Credits and Insurance Credits

(71) Applicant: John Hancock Life Insurance Company (U.S.A.), Boston, MA (US)

(72) Inventors: David Ray Plumb, Wrentham, MA (US); Daragh M. O'Sullivan, Boston, MA (US); Geoff Gittins, Boston, MA (US); A. Alex Silva, Foxboro, MA (US); Bradley Scott Rokosh, Boston, MA (US)

(21) Appl. No.: 14/830,104

(22) Filed: Aug. 19, 2015

Related U.S. Application Data
(60) Provisional application No. 62/041,291, filed on Aug. 25, 2014.

(51) Int. Cl. G06Q 40/08

(52) U.S. Cl. CPC G06Q 40/08

(57) ABSTRACT

Excess returns on a portfolio that funds an LTC insurance policy may be shared with policyholders by determining an excess return for the portfolio, automatically determining interest credits for a policyholder based on the excess return, automatically determining insurance credits for the policyholder based on previous period gains or losses of the long-term care insurance policy and apportioned to individual policyholders, automatically determining potential earnings credits for the policyholder based on the determined interest credits and insurance credits, and automatically providing a benefit to the policyholder and updating a policyholder record maintained in a tangible non-transitory computer-readable storage based on the determined potential earnings credits.

### CROSS-REFERENCE TO RELATED APPLICATION(S)

This patent application claims the benefit of U.S. Provisional Patent Application No. 62/041,291 entitled AUTOMATIC CREDITING FOR LONG TERM CARE INSURANCE BASED ON INTEREST CREDITS AND INSURANCE CREDITS filed on Aug. 25, 2014 (Attorney Docket No. 2661/1005), which is hereby incorporated herein by reference in its entirety.

The subject matter of this patent application also may be related to the subject matter of U.S. patent application Ser. No. 13/547,759 entitled AUTOMATIC CREDITING FOR LONG TERM CARE INSURANCE filed on Jul. 12, 2012 (Attorney Docket No. 2661/1001), which is hereby incorporated herein by reference in its entirety.

### FIELD OF THE INVENTION

The present invention relates generally to automatic crediting for long term care insurance.

### BACKGROUND OF THE INVENTION

Generally speaking, long-term care (LTC) insurance is insurance that provides valuable support and financial resources that help cover the cost of long-term care a person might need in the event of a chronic illness and unable to perform without substantial assistance at least two activities of daily living (bathing, continence, dressing, eating, toileting, transferring) or require substantial supervision due to a cognitive impairment, such as Alzheimer's disease. By helping to protect the person's assets, and giving the person choice and control over where he or she receives care—including in the person's own home—LTC insurance helps a person and his or her family face the future with confidence.

Companies that offer LTC insurance typically offer policies with benefit increase or so-called “inflation protection options” in which the amount of the benefit increases over time at a rate that is either fixed (e.g., by a selected percentage, such as 3%, 5%, etc.) or variable (e.g., based on the consumer price index). The increases may be applied as either simple rate increases or compound rate increases. Policies with fixed rate increases may have fixed (level) premiums, i.e., a fixed monthly or annual premium that does not change over the life of the policy. The premium for such policy is based on the amount of the fixed benefit increase selected by the policyholder, i.e., the premiums for a policy with a 3% fixed-rate inflation protection option would be higher than the premiums for a similar policy with no inflation protection option, the premiums for a policy with a 5% fixed-rate inflation protection option would be higher than the premiums for a similar policy with a 3% fixed-rate inflation protection option, etc. Policies may also offer inflation protection with increasing premiums related to increasing benefits (e.g. guaranteed purchase options). U.S. Pat. No. 7,392,202 and U.S. Published Patent Application Nos. 2007/0214022 and 2010/0076792 discuss various aspects of traditional LTC insurance policies and inflation protection options.

Currently, a very small percentage of people over the age of 50 (perhaps around 8%) have LTC insurance, due in large part to the high cost for such policies.

### SUMMARY OF EXEMPLARY EMBODIMENTS

In accordance with one embodiment of the invention, a long-term care insurance system provides automatic crediting for a long-term care insurance policy. The long-term care insurance policy is associated with a portfolio having a portfolio rate of return in a given plan period and/or gains/losses arising from insurance experience such as morbidity, mortality, and lapse. The system includes a policyholder records storage, a plan parameters storage, and a LTC insurance policy processor coupled to the policyholder records storage and the plan parameters storage, where the LTC insurance policy processor is configured to determine an excess return based on the portfolio rate of return, automatically determine interest credits for a policyholder based on the excess return and information from the policyholder records storage and the plan parameters storage, automatically determine insurance credits for the policyholder based on apportioning previous period insurance gains or losses of the long-term care insurance policy, automatically determine potential earnings credits for the policyholder based on the determined interest credits and insurance credits, and automatically provide a benefit to the policyholder and update a policyholder record in the policyholder records storage based on the determined potential earnings credits.

In accordance with another embodiment of the invention there is provided apparatus comprising a tangible, non-transitory computer-readable medium having embodied therein computer program instructions, which, when run on a processor, establishes processes for automatic crediting for a long-term care insurance policy. The long-term care insurance policy is associated with a portfolio having a portfolio rate of return in a given plan period and/or gains/losses arising from insurance experience such as morbidity, mortality, and lapse. The processes include:
a first computer process in which an excess return is determined based on the portfolio rate of return;
a second computer process in which interest credits for a policyholder are automatically determined based on the excess return, wherein automatically determining credits for the policyholder comprises:
   determining a notional or actual allocated reserve value for the policyholder; and
   automatically determining interest credits based on the excess return and the determined allocated reserve value;
a third computer process in which insurance credits for the policyholder are automatically determined based on previous period gains or losses of the long-term care insurance policy and apportioned to individual policyholders;
a fourth computer process in which potential earnings credits for the policyholder are automatically determined based on the determined interest credits and insurance credits; and
a fifth computer process in which a benefit is automatically provided to the policyholder and a policyholder record maintained in a tangible non-transitory computer-readable storage is automatically updated based on the determined potential earnings credits.

In various alternative embodiments, determining the insurance credits may involve determining a total block actual gain for the policy and determining the insurance credits based on apportioning the total block actual gain to individual policyholders. Long-term care benefits associated with the policyholder may be automatically increased based on the potential earnings credits. The benefit may be provided when the number of potential earnings credits exceeds any deficit in credits associated with policyholder. The benefit may be automatically provided based on the number of potential earnings credits less any deficit in credits associated with the policyholder. Benefits may be automatically increased by determining a single premium rate for the policyholder and automatically increasing benefits associated with the policyholder based on the number of potential earnings credits and further based on the single premium rate determined for the policyholder. A deficit in credits associated with the policyholder may be decreased based on the potential earnings credits when the number of potential earnings credits is less than any deficit in credits associated with the policyholder. A deficit in credits associated with the policyholder may be increased based on the potential earnings credits when the number of potential earnings credits is negative. Potential earning credits may be used for such things as reducing premiums for the policyholder, providing a credit to the policyholder, or providing a refund to the policyholder.

Credits may be accumulated in a policyholder accumulated credit account, and such accumulated credits may be invested and the accumulated credit account may be updated based on investment returns or losses. Accumulated credits may be used for such things as long term care expenses associated with a claim, to provide a death benefit, or to provide a refund.

Additional embodiments may be disclosed and claimed.

### BRIEF DESCRIPTION OF THE DRAWINGS

The foregoing features of embodiments will be more readily understood by reference to the following detailed description, taken with reference to the accompanying drawings, in which:

FIG. 1 is a schematic block diagram of an LTC insurance system in accordance with an exemplary embodiment of the present invention;

FIG. 2 schematically shows some of the types of policyholder account information that may be maintained in the policyholder account storage, in accordance with an exemplary embodiment;

FIG. 3 schematically shows some of the types of plan parameter information that may be maintained in the plan parameter storage, in accordance with an exemplary embodiment;

FIG. 4 is a schematic diagram showing how PEC is determined in accordance with one specific exemplary embodiment;

FIG. 5 is a description of the novel crediting feature in the form of a flow chart, in accordance with the specific exemplary embodiment; and

FIG. 6 is a schematic diagram showing certain aspects of a LTC plan with an accumulated credit account feature, in accordance with an exemplary embodiment.

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

Definitions. As used in this description and the accompanying claims, the following terms shall have the meanings indicated, unless the context otherwise requires:

“Credit” refers to some value allocated or apportioned to a policyholder. A credit may be monetary or non-monetary. As but one example, purely to help demonstrate how credits might work, every dollar of value allocated or apportioned to a policyholder may equal one credit. It should be noted, however, that credits may be determined in other ways, such as, for example, every $N equals one credit, where N may be greater than or less than one.

“Plan Period” is a period at which Excess Returns are administered as discussed herein. In typical embodiments, the plan period is annually on or around the anniversary of the plan, although alternative embodiments may use other plan periods, such as semi-annually, quarterly, monthly, biennially, etc. The present invention is not limited to any particular plan period.

“Portfolio” is an account or portion of an account that contains the assets supporting LTC insurance policies of the type discussed herein. Typically, the assets in the portfolio may change over time at the sole discretion of the plan administrator, and the assets may be invested in any of a variety of ways. The present invention is not limited to any particular portfolio or investment methodology and therefore the Portfolio can be any asset base including but not limited to the company's portfolio or an external index (such as S&P or Barclays).

“Portfolio Rate of Return” (which may be abbreviated as “PRR”) is a rate of return attributed to the Portfolio in a given plan period. In certain embodiments, the PRR is not a declared rate at the discretion of the plan administrator but instead is determined by a mathematical calculation which is on file with the applicable state regulators. For example, PRR may be based on net income on invested assets, divided by the asset values at the beginning of the plan period plus weighted cashflow during the plan period. In other embodiments, the PRR may be determined in other ways and may be a declared rate. It should be noted that embodiments may use various quantifications for PRR. For example, in some embodiments, PRR may be a percentage (e.g., the return on investment is X %), while in other embodiments, PRR may be an actual value (e.g., the return on investment is $X). The present invention is not limited to any particular methodology for determining the PRR.

“Threshold” (which may be abbreviated as “THR”) is a predetermined notional or actual threshold value used to determine Excess Returns in a given plan period. As with the PRR, embodiments may use various quantifications for THR. For example, in some embodiments, THR may be a percentage (e.g., Y %), while in other embodiments, THR may be an actual value (e.g., $Y). The present invention is not limited to any particular threshold, and it should be noted that the threshold may be zero in some embodiments.

“Excess Return” or “Excess Returns” (which may be abbreviated as “ER”) is the amount by which the PRR exceeded or fell below the THR. In essence, ER=PRR−THR. Some or all of the value of the ER may be shared with the policyholders in a variety of ways as discussed herein. It should be noted that, in exemplary embodiments, ER may be negative under some conditions, and both positive and negative ER may be shared with the policyholders as discussed herein. As with the PRR and THR, embodiments may use various quantifications for ER. For example, in some embodiments, ER may be a percentage (e.g., Z %), while in other embodiments, ER may be an actual value (e.g., $Z). As but one example, purely to help demonstrate how ER might work, if PRR were determined to be 6.3% and THR was set at 3%, then ER might be 3.3%. As another example, purely to help demonstrate how ER might work, if PRR were determined to be $5 million and THR was set at $4 million, then ER might be $1 million. The present invention is not limited to any particular way of determining ER. It should be noted that, if THR is zero, then the determination of ER may exclude or ignore a THR value.

“Allocated Reserve Value” (which may be abbreviated as “ARV”) is a reserve value determined for the policyholder and generally is related to the amount of premiums paid by the policyholder and may be based on notional or actual values. In various embodiments, the ARV is used to determine credits that can be used as discussed herein. The initial ARV for a policyholder typically is based on a formula, e.g., using pre-determined tables that vary by issue age, policy year, benefit period, and payment option (e.g., limited pay) and are adjusted by a factor to incorporate marital status, risk class, daily vs. monthly benefits, elimination period or deductible, and optional riders. The ARV for each policyholder is typically re-determined each plan period, e.g., to account for the impact from benefit changes and/or other benefit additions. The ARV typically starts at or near zero (e.g., due to early premiums being used to cover up-front plan costs) and increases over time as the policyholder pays his or her premiums into the plan, and therefore there generally will be little or no credits in the early years of a policy. It should be noted that the sum of all policyholders' ARVs may or may not add up to the amount of reserves used to fund the portfolio. The present invention is not limited to any particular methodology for determining ARV.

“Interest Credits” is the amount of credits determined for the policyholder based on the ER and the policyholder's ARV. Interest Credits, by virtue of being credits, may be monetary or non-monetary. Since ER can be positive or negative, so too can Interest Credits. It should be noted that Interest Credits may be rounded up or down, e.g., to the nearest penny, dollar, etc. such that, in some circumstances, even if ER (and hence Interest Credits) is a positive non-zero value, the Interest Credits could be rounded to zero. As but one example, purely to help demonstrate how Interest Credits might work, if ER were determined to be 3.3% and the policyholder's ARV was determined to be $1000, then Interest Credits might be $33.00 of credits (i.e., in this example, Interest Credits=ER×ARV), or Interest Credits may be 33 credits (i.e., where $1 is mapped to 1 credit), or Interest Credits may be 33/N credits (i.e., where $1 is mapped to N credits, where N may be greater than or less than one). As another example, purely to help demonstrate how Interest Credits might work, if ER were determined to be a numerical value such as $1 million, then Interest Credits might be a portion of that amount determined using the ARV (e.g., Interest Credits might be a pro rata portion equal to ER times ARV divided by the sum of all policyholders' ARVs).

“Insurance Credits” is the amount of credits determined for the policyholder based on LTC insurance policy gains or losses related to such things as policy lapses, mortality, and morbidity (referred to herein as the “Total Block Actual Gain” or “TBAG”). Generally speaking, Insurance Credits are retrospective but applied prospectively, i.e., any actual gain or loss from the prior period will be apportioned to policyholders in-force at the time that the credit is paid. Apportionment may be based on policyholders' expected contribution to the TBAG. One method of apportionment may be according to a predetermined formula as discussed more fully below.

“Benchmark Assumptions” or “Benchmark Experience” is the benchmark used to compare to actual policy performance experience. Examples of Benchmark Experience include but are not limited to a defined set of assumptions or an external index.

“Total Block Actual Gain” (which may be abbreviated as “TBAG”) is the total gain or loss from experience on the whole block. For example, insurance experience may include but is not limited to policy lapses, mortality, morbidity, expenses, taxes, and investments. TBAG may also take into account expected gains/loss in the future. To calculate this gain, actual experience is compared to Benchmark Experience.

“Policyholder Pricing Gains” (which may be abbreviated as “PPG”) are individual policy level expected gains. Original PPGs are the individual policy level expected gains based on pricing assumptions at issue. Adjusted PPGs are individual policy level expected gains with cohort adjustments to reflect differences in pricing of different cohorts of business.

“Policyholder Pricing Claims” (which may be abbreviated as “PPC”) are individual policy level expected claims based on pricing assumptions at issue. PPCs are related to Original PPGs in that the expected policyholder pricing gains are based in part on the original expected policyholder pricing claims and can be used in place of Original PPGs for determining insurance credits in certain exemplary embodiments.

“True Up Ratio” or “Gain/Loss %” (which may be abbreviated as “GL %”) compares the TBAG to the PPGs. In one exemplary embodiment, GL %=(TBAG−sum of policyholder Adjusted PPGs)/sum of policyholder original PPGs, and Insurance Credits for an individual policyholder=Adjusted PPG+Original PPG*GL %. In another exemplary embodiment, GL %=(TBAG−sum of policyholder Adjusted PPGs)/sum of policyholder PPCs, and Insurance Credits for an individual policyholder=Adjusted PPG+PPC*GL %.

“Potential Earnings Credits” (which may be abbreviated as “PEC”) is the amount of credits determined for the policyholder based on Interest Credits and Insurance Credits. In one exemplary embodiment, PEC is the sum of Interest Credits and Insurance Credits, although PEC could be determined other ways, e.g., by weighting one more than the other, or by incorporating additional information into the PEC determination formula. PEC, by virtue of being credits, may be monetary or non-monetary. Since Interest Credits and Insurance Credits can be positive or negative, so too can PEC. It should be noted that positive Interest Credits can partially or completely offset negative Insurance Credits and vice versa. It should be noted that PEC may be rounded up or down, e.g., to the nearest penny, dollar, etc. such that, in some circumstances, even if PEC is a positive non-zero value, the PEC could be rounded to zero.

“Past Deficit Balance” (which may be abbreviated as “PDB”) represents a deficit in credits carried forward from previous plan periods. PDB may be used in some embodiments to accumulate credits over multiple plan periods. The PDB may, and typically will, be maintained in a tangible, non-transitory computer-readable medium along with other relevant information for the policyholder. In the pseudo-code shown below, PDB can have values less than or equal to zero (where a negative value indicates a deficit in credits from previous plan periods), although it should be noted that the PDB and calculations relating to the PDB may be modified to use other values, such as positive PDB values representing a deficit.

“Excess Earnings Credits (which may be abbreviated as “EEC” or “EECs”) is the amount, if any, of PEC over and above any deficit of credits from past plan periods. As but one example, purely to help demonstrate how EEC might work, if PEC were determined to be $33.00 of credits and PDB was −$11.00 in credits, then EEC might be $22.00 of credits. In certain exemplary embodiments discussed herein, EEC is used to automatically increase benefits for the policyholder, while other embodiments may use EEC in other ways as discussed herein.

“Single Premium Rate” (which may be abbreviated as “SPR”) is a measure of the cost to provide one unit of additional benefits for a policyholder in certain embodiments of the present invention described herein, where the unit and the corresponding Single Premium Rate typically are determined by the plan administrator. In certain exemplary embodiments, SPRs are determined using tables of single premium rates that vary by issue age, policy year, and benefit period and are adjusted by a factor to incorporate marital status, risk class, daily vs. monthly benefits, elimination period or deductible, and optional riders. Thus, different policyholders may (and often do) have different SPRs. SPRs are typically on file with an applicable regulator and may change over time, for example, due to a future in-force rate increase on the policy; such changes in the SPRs typically require approval of an applicable regulator.

“Period Benefit Increase” (which may be abbreviated as “PBI”) is the amount of additional benefits that will be provided to the policyholder in a given plan period in certain embodiments of the present invention described herein. In essence, PBI=EEC/SPR.

It should be noted that these terms are defined as such for the purposes of describing certain exemplary embodiments in this patent application; the definitions do not necessarily apply to similar terms used in actual LTC insurance policies having features described herein, and vice versa. It should be noted that various aspects of crediting described herein may be applied to other types of insurance policies, such as, for example, life/annuity policies with a long-term care rider.

Embodiments of the present invention utilize various methodologies to share certain ER and TBAG with the LTC policyholders. Generally speaking, the PRR is determined for the portfolio in a given plan period, ER is determined using the PRR and the THR, and the Interest Credits is determined for each policyholder using the ER and the policyholder's ARV. Insurance Credits is also determined for each policyholder based on the apportionment of the TBAG. PEC is determined for each policyholder based on the policyholder's Interest Credits and Insurance Credits. EEC may be used for any of a variety of purposes, such as, for example, reducing premiums, providing a credit to the policyholder, providing a refund of premiums to the policyholder, providing a death benefit, placing credits or funds into an interest-bearing or other account to use for certain purposes (e.g., applying toward deductibles), providing additional benefits to the policyholder, or other ways of sharing the ER and TBAG, and the credits may be applied through an automatic crediting process in which the credits are guaranteed to be utilized in a specified manner when specific conditions (typically specified by contract) are met as discussed more fully below. In certain embodiments, any deficit in credits from prior plan periods must be made up before a net excess of credits (i.e., EEC) are used for any of such purposes. In certain embodiments, the credits may be accrued and may be used, e.g., for a claim, upon death, or upon policy lapse.

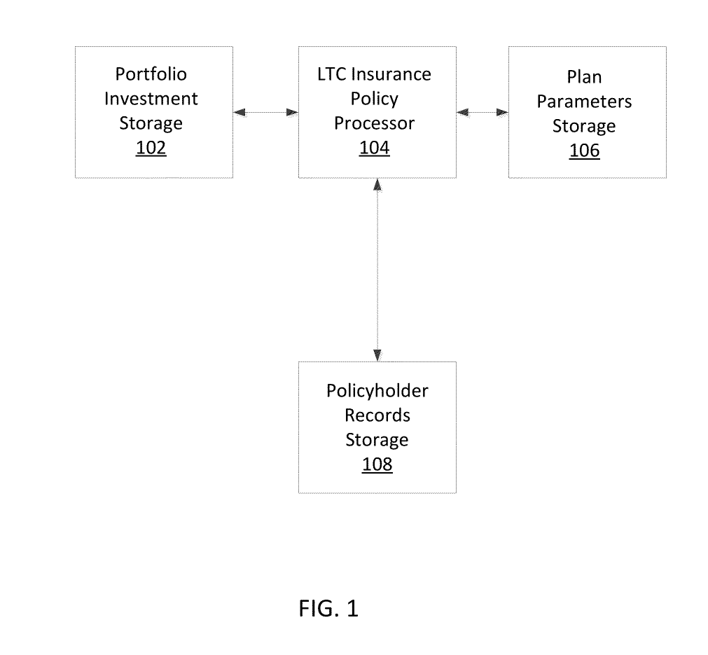

Certain exemplary embodiments are discussed below with reference to the LTC insurance system 100 shown schematically in FIG. 1. At the heart of the LTC insurance system 100 is an LTC insurance policy processor 104 that uses portfolio investment information from a portfolio investment storage 102, plan parameter information from a plan parameter storage 106, and policyholder records from a policyholder records storage 108 to implement any of various features discussed herein. The LTC insurance policy processor 104 is typically a specially-programmed computer having a microprocessor, memory for storage of program instructions and operating parameters, and various communication interfaces for interfacing with other systems and peripherals.

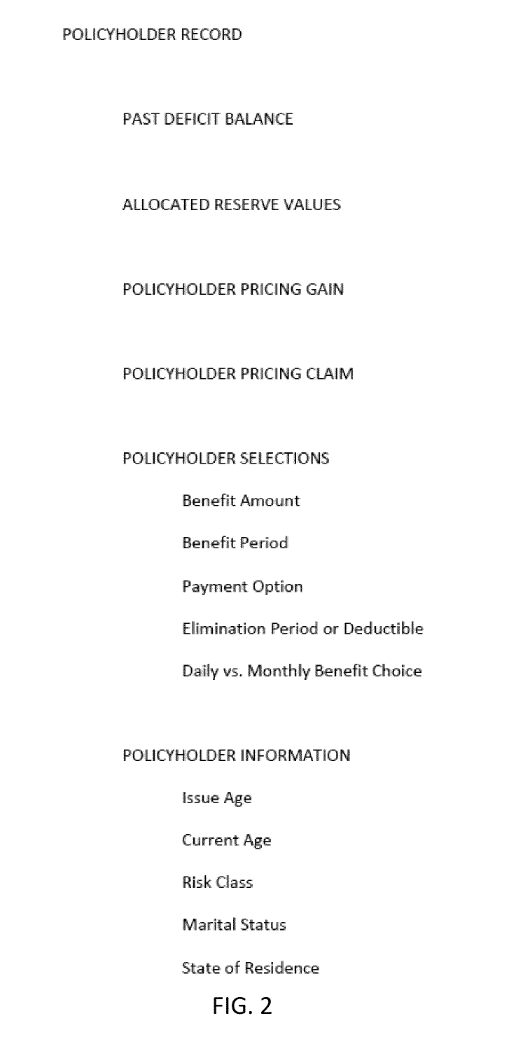

FIG. 2 schematically shows some of the types of information that may be maintained in each policyholder record in the policyholder records storage 108, in accordance with an exemplary embodiment. Among other things, a policyholder record may include such things as the policyholder's PDB, the policyholder's ARV, the policyholder's PPG, the policyholder's PPC, policyholder selections (e.g., benefit amount, benefit period, payment option, elimination period or deductible, daily vs. monthly benefit choice), and policyholder information (e.g., name, address, social security number, issue age, attained age, risk class, marital status).

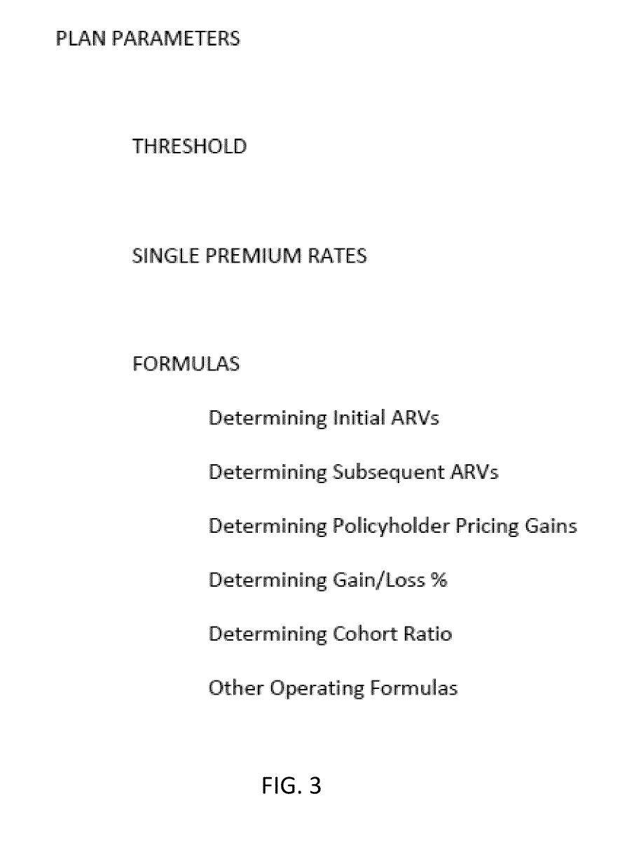

FIG. 3 schematically shows some of the types of plan parameter information that may be maintained in the plan parameter storage 106, in accordance with an exemplary embodiment. Among other things, the plan parameter information may include such things as the THR, the SPRs, and the various formulas used for determining such things as the initial ARV, subsequent ARVs, initial PPGs, subsequent PPGs, and other operating formulas.

### Premium Offset Feature

Certain embodiments of the present invention relate to a LTC insurance product having a novel premium offset feature in which the LTC policy premiums for qualifying policyholders are offset (with exception to be noted) when the policyholder has EEC in a given plan period as discussed more fully below. The policyholder must pay the “Net Premium” (defined as the Policy Premium—EEC) to keep the policy in force. The Net Premium is less than or equal to the Policy Premium. If the policyholder has negative PEC in a given plan period, the policyholders' policy premiums are not increased, although any aggregate deficit of credits attributable to a given policyholder must be made up before premiums will be offset for that policyholder in future plan periods in which the PEC is positive. Thus, in this context, a qualifying policyholder (i.e., a policyholder for which premiums will be automatically offset) is a policyholder whose PEC in the current plan period exceeds any deficit of the policyholder from prior plan periods. Even though the policy premium is not increased when the PEC is negative, the novel premium offset feature allows the plan administrator to recoup any PDB before providing credits to the policyholder. If the EEC is greater than the policy premium, the Net Premium is zero and any remaining EEC is deposited into an account where the credits are accumulated. The policyholder also has the option to pay a portion or the full Policy Premium and deposit the a portion or the full EEC into this account rather than using it to pay the premium. In a design with increasing policy premiums, the credits in this account can be used to offset increasing policy premiums, e.g., so that the resulting net premium is more level and may be positioned as a lower net cost to the policyholder. Additionally or alternatively, the credits in this account can be used for any of a variety of things, such as paying premiums, paying for additional stay at home services, providing death benefits, provide as a surrender benefit, or pay long term care expenses, to name but a few.

Thus, if the policyholder has positive PEC in the plan period, then the PEC determined for the policyholder is used to provide a credit to the policyholder to the extent such PEC exceeds any deficit from past plan periods (i.e., PDB). If PEC does not overcome any deficit of the policyholder from prior plan periods, then the policyholder's existing deficit from past plan periods is reduced by the amount of the PEC, thereby reducing the deficit and increasing the chances that the policyholder will receive increased benefits in the future. If the policyholder has negative PEC in the plan period, then PEC represents a deficit that is added to any deficit from prior plan periods, and, as mentioned above, this deficit must be made up in future plan periods before the policyholder's benefits will be increased based on EEC.

The overall LTC insurance plan is designed so that, in theory, as long as the PEC is generally positive on a regular basis, the plan administrator should not need to re-price premiums on new policies due to the investment and insurance (such as claims) performance (although re-pricing may occur for other reasons). If the PRR drops below the predetermined threshold for a prolonged period without being offset by Insurance Credits or claims experience deteriorates beyond the Benchmark Assumptions for a prolonged period without being offset by Interest Credits, then the plan administrator may choose to re-file the product for new business or in-force business with any or all of a lower interest rate threshold, higher claims Benchmark Assumptions, and associated higher premium rates.

The following is a description of one specific exemplary embodiment of an LTC policy with the described premium offset feature.

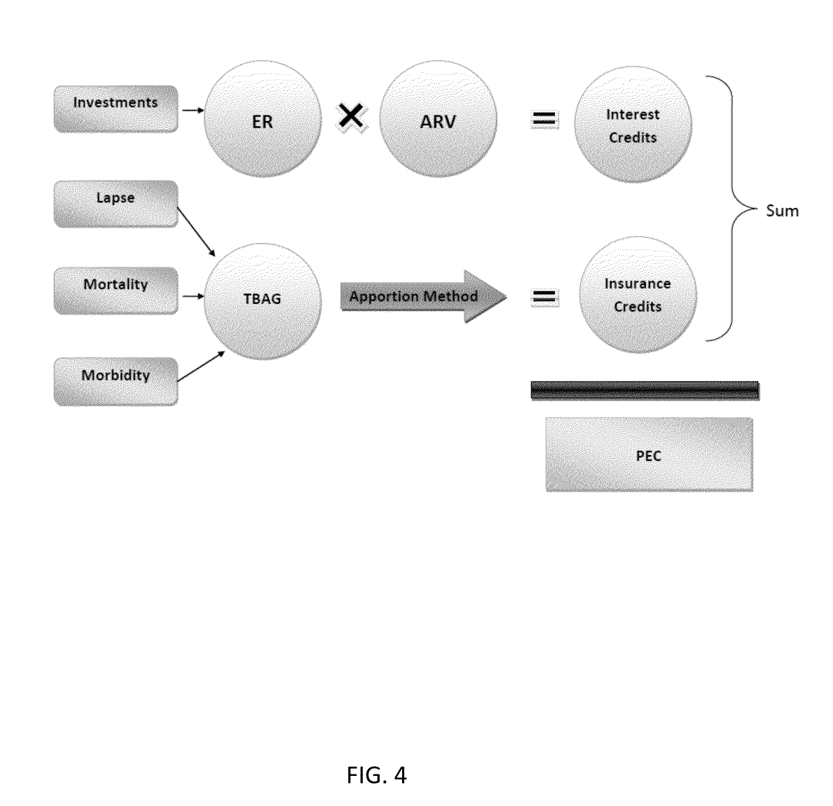

FIG. 4 is a schematic diagram showing how PEC is determined in accordance with one specific exemplary embodiment. In this one specific exemplary embodiment, the plan period is annual, and the PRR is a declared interest rate specified as a percentage, although alternative embodiments may determine the PRR in other ways. THR also is a percentage and in this specific exemplary embodiment is 3% for the annual plan period, although alternative embodiments may use other thresholds. Thus, in this one specific exemplary embodiment, ER=PRR−3%. A lower threshold (e.g., 0% or 2%) might provide more EEC to the policyholders but generally would require a much higher premium in order to pay the additional excess returns. In this specific exemplary embodiment, Interest Credits are equal to ER×ARV, although alternative embodiments may determine Interest Credits based on ER and ARV in other ways. TBAG (LTC policy gains or losses, such as from policy lapses, mortality, and morbidity) are apportioned to the policyholders in the form of Insurance Credits as discussed more fully below. In this specific exemplary embodiment, PEC is equal to the sum of Interest Credits and Insurance Credits, although alternative embodiments may determine PEC based on Interest Credits and Insurance Credits in other ways (e.g., weighting one more than the other). It should be noted that positive Interest Credits can partially or completely offset negative Insurance Credits and vice versa. Thus, for example, if the policyholder is allocated 6 Interest Credits and (−2) Insurance Credits, the PEC for the policyholder would be 4 credits.

If PEC is greater than zero, then PEC represents the potential number of earning credits that can be used in this one specific exemplary embodiment to offset premiums for the policyholder or deposit into the accumulation account; this number is first used to reduce any deficit from prior plan periods, with any remaining credits (i.e., EEC) used to offset premiums or deposit into the accumulation account.

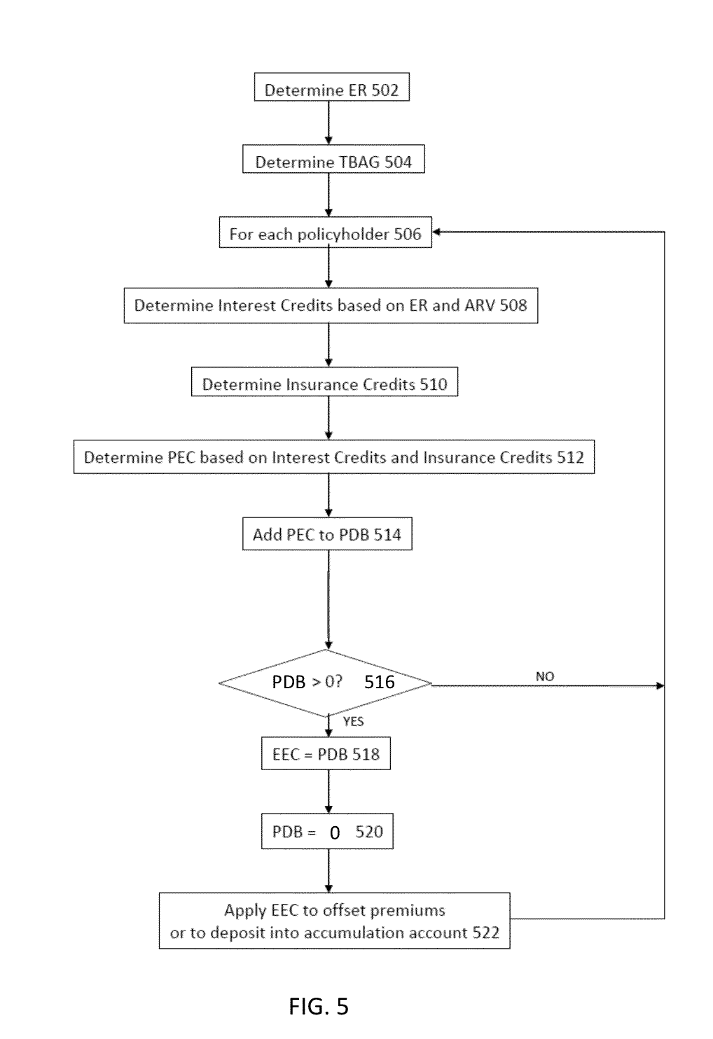

FIG. 5 is a description of the novel crediting feature in the form of a flow chart, in accordance with the specific exemplary embodiment described above. In block 502, the ER is determined, e.g., based on the PRR and the THR. In block 504, the TBAG is determined. Then, for each policyholder (block 506), Interest Credits is determined in block 508 based on ER and ARV (where ARV typically is determined based at least in part on information in the policyholder record), and Insurance Credits is determined in block 510 based on apportionment of the TBAG to individual policyholders. Then, the policyholder's PEC is determined based on Interest Credits and Insurance Credits, in block 512. A determination is then made as to whether or not there is any EEC for the policyholder based on the PEC and the policyholder's PDB, e.g., by adding PEC to PDB in block 514 and determining if the resulting value of PDB is greater than zero in block 516. If there is no EEC (NO in block 516), then the logic returns to block 506 until all policyholder records have been processed. If, on the other hand, the resulting value of PDB is greater than zero (YES in block 516), then EEC is set equal to the value of PDB in block 518 and the value of PDB is reset to zero in block 520. In block 522, the EEC is applied to offset premiums for the policyholder or to deposit in an accumulation account of the policyholder. From block 522, the logic returns to block 506 until all policyholder records have been processed. It should be noted that an implementation of this specific exemplary embodiment of the premium offset feature by the LTC insurance policy processor 104 need not (but may) follow the logic flow shown in FIG. 5. Rather, the logic flow shown in FIG. 5 is intended mainly for describing the effects of this specific exemplary embodiment of the premium offset feature.

The following pseudo-code is used to demonstrate, in algorithmic form, certain aspects of this specific exemplary embodiment of the automatic benefit increase feature described above:

| | |
|---|---|
| (1) | Determine PRR for the plan period; |
| (2) | ER = PRR - THR; |
| (3) | For each policyholder |
| (4) | Determine ARV for the policyholder; |
| (5) | Interest Credits =ER × ARV; |
| (6) | Insurance Credits = allocation of TBAG; |
| (7) | PEC = Interest Credits + Insurance Credits |
| (8) | PDBₜ = PDBₜ₋₁ + PEC; |
| (9) | If (PDBₜ > 0) |
| (10) | EEC = PDBₜ; |
| (11) | PDBₜ = 0; |
| (12) | Apply EEC to offset premium or deposit |
| | into the accumulation account; |
| (13) | Endif |
| (14) | Endfor |

The following is a line-by-line discussion of the above pseudo-code:

Line (1): The PRR is determined for the plan period. The present invention is not limited to any particular manner for investing the Portfolio or to any particular manner for determining the PRR.

Line (2): The Excess Returns is calculated, i.e., ER=PRR−THR. This value will be positive if the PRR exceeded the threshold but will be negative if the PRR was below the threshold.

Line (3): The pseudo-code from lines (4)-(12) is performed for each policyholder.

Line (4): Determine the ARV for the policyholder.

Line (5): The Interest Credits value is computed for the policyholder based on the Excess Return and the Allocated Reserve Value.

Line (6): The Insurance Credits is computed for the policyholder based on apportionment of TBAG.

Line (7): PEC is determined based on Interest Credits and Insurance Credits, i.e., PEC=Interest Credits+Insurance Credits. If PEC is greater than zero, then PEC represents the potential number of credits that could be used to offset the policyholder's premiums or be deposited into the accumulation account, although this number will be decreased if the policyholder has a non-zero deficit from prior plan periods. If ER is less than zero, then PEC represents a deficit that will create a deficit or increase any existing deficit from prior plan periods.

Line (8): The PEC is added to the policyholder's PDB (in this example, PDBₜ is the new PDB for the current plan period t and PDBₜ₋₁ is the PDB carried forward from prior plan period t−1. If PEC is a positive value, then PEC will decrease any existing deficit from prior plan periods, and if PEC is sufficiently large, may wipe out or even exceed any existing deficit from prior plan periods. If PEC is a negative value, then PEC will create a deficit or increase any existing deficit from prior plan periods.

Line (9): If, after adding PEC to PDB, the value of PDB is greater than zero, then that means there are Excess Earnings Credits that can be used to offset the policyholder's premiums or be deposited into the accumulation account, and lines (10)-(12) are performed. Otherwise, there are no Excess Earnings Credits that can be used to increase the policyholder's benefits.

Line (10): EEC is set equal to PDBₜ. Thus, EEC is the excess earnings credits that can be used to increase the policyholder's benefits.

Line (11): PDBₜ is set to zero to indicate that the policyholder is not (or is no longer) carrying a deficit.

Line (12): EEC may be used to offset premiums or deposit into the accumulation account.

Line (13): This is just an indicator of the end of the “if” statement in line (9).

Line (14): This is just an indicator of the end of the “for” statement in line (3).

It should be noted that this pseudo-code may, but does not necessarily, represent an actual implementation in that certain variables/values have been defined mainly for the sake of convenience and to facilitate the description of the exemplary embodiment. Thus, for example, an actual implementation might not expressly use certain variables, such as ER and PEC, which, in essence, are intermediate values used in the various computations. Also, various steps may be performed in a different order; for example, the ARVs for all policyholders may be determined before processing the policyholder records. Based on the above descriptions, including the flow chart in FIG. 4 and the above pseudo-code, a person of ordinary skill in the art of computer programming would be capable of implementing the described premium offset feature without undue experimentation.

### Determining Insurance Credits

As discussed above, policy gain/loss from the prior period (i.e., Total Block Actual Gain, TBAG) is apportioned to the policyholders in the form of Insurance Credits. In one exemplary embodiment, the TBAG equals the gain (or loss) incurred during the policy period based on actual morbidity, mortality, and lapse experience compared to a conservative set of assumptions (Benchmark Experience) that are locked in at issue, although in various alternative embodiments the TBAG may be determined using one or more of these components and/or other gains and/or losses. In exemplary embodiments, any certain unexpected events (such as adjustments due to revised past calculated TBAG) are amortized over some number of years (e.g., five years), although alternative embodiments may handle adjustments differently. The TBAG may be apportioned among policyholders based on each policyholder's expected contribution to the TBAG.

In a first specific exemplary embodiment, the TBAG is determined as follows:

TBAG=

Expected Cash Flow during the period(based on Benchmark

Assumptions)−

Actual Cash flow during the period+

Expected Active Life Reserve(based on Benchmark Assumptions and

Benchmark population)−

Expected Active Life Reserve(based on Benchmark Assumptions and

Actual population)+

Expected Disabled Life Reserve(based on Benchmark Assumptions and

Benchmark population)−

Expected Disabled Life Reserve(based on Benchmark Assumptions and

Actual population)+/−

Adjustments due to revised past calculated TBAG(amortized over

some number of years)

In this first specific exemplary embodiment, the TBAG is apportioned as follows:

Insurance Credits=Adjusted PPGs+Original PPGs*GL %

where:

Original PPGs are the expected gains based on expected experience using Benchmark Assumptions compared to expected experience using pricing assumptions and locked in at time of issue;

Adjusted PPGs include adjustments which help maintain equity among cohorts when the new business is re-priced or pricing assumptions are materially different; and

GL %=(TBAG−Sum of the Block's Adjusted PPGs)/Sum of the Block's

Original PPGs.

In this first specific exemplary embodiment, Insurance Credits and GL % alternatively can be determined using PPCs in place of Original PPGs. As discussed above, PPCs are the expected claims based on pricing assumptions and locked in at time of issue and are related to Original PPGs in that the expected policyholder pricing gains are based in part on the original expected policyholder pricing claims.

Thus, the excess (or shortfall) of TBAG over the sum of the Block's Adjusted PPGs is apportioned back to each individual policyholder, e.g., based on the policy's Original PPG or PPC.

In a second specific exemplary embodiment, the TBAG is determined as follows:

TBAG for period t=

Sum of Expected Cash Flow(based on Benchmark Assumptions)during

period t−

Sum of Actual Cash Flow during period t+

Benchmark ALR at end of period t(based on actual population at beginning

of period t projected to end of period t using Benchmark Assumptions)−

Benchmark ALR at end of period t(based on actual population at end of

period t)+

Benchmark DLR at end of period t(based on actual population at beginning

of period t projected to end of period t using Benchmark Assumptions)−

Benchmark DLR at end of period t(based on actual population at end of

period t)+

α

where:

Cash Flow=Benefits−Premiums (no expenses);

ALR=Active Life Reserve=Actuarial Present Value of future Benchmark Cash Flows for active lives;

DLR=Disabled Life Reserve=Actuarial Present Value of future Benchmark Cash Flows for disabled lives; and

α=adjustment due to revised past calculated TBAG (both gains and losses amortized over some number of years).

In this second specific exemplary embodiment, the TBAG is apportioned as follows:

Insurance Credits in period t+1=

Adjusted PPG in period t+

Original PPG in period t*GL % in period t

where:

Original PPGs are the expected gains based on expected experience using Benchmark assumptions compared to expected experience using pricing assumptions and locked in at time of issue;

Adjusted PPGs include cohort ratios which help maintain equity among cohorts if and when new business is re-priced or pricing assumptions are materially different;

Adjusted PPG=Original PPG*Sum of Cohort Ratios; and

GL % in period t=

(TBAG in period t−

Sum of all policyholders' Adjusted PPGs in period t)/Sum

of all policyholders' Original PPGs in period t

In this second specific exemplary embodiment, each time new business is re-priced or pricing assumptions are materially different, in order to maintain equity between in-force policyholders and new policyholders, a vector of Cohort Ratios is calculated, where the Cohort Ratios vary by period and are applied to all in-force PPGs through the Adjusted PPGs. In this second specific exemplary embodiment, the Cohort Ratio is determined as follows:

Cohort Ratio in period t=

(Total Block Expected Gain in period t−

Sum of all policyholders' Adjusted PPGs in period t)/Sum

of all policyholders' PPGs in period t)

where:

Total Block Expected Gain for period t=

Sum of Benchmark Cash Flow during period t−

Sum of Best Estimate Cash Flow during period t+

Benchmark ALR at end of period t(based on best estimate population at

beginning of period t projected to end of period t using Benchmark assumptions)−

Benchmark ALR at end of period t(based on best estimate population at end

of period t)+

Benchmark DLR at end of period t(based on best estimate population at

beginning of period t projected to end of period t using Benchmark assumptions)−

Benchmark DLR at end of period t(based on best estimate population at end

of period t)+

α.

For this determination of TBAG, “best estimate” assumptions are current best estimate assumptions used in the current re-price or time of materially different pricing assumptions.

In this second specific exemplary embodiment, Insurance Credits, Adjusted PPG, GL %, and Cohort Ratio alternatively can be determined using PPCs in place of Original PPGs. As discussed above, PPCs are the expected claims based on pricing assumptions and locked in at time of issue and are related to Original PPGs in that the expected policyholder pricing gains are based in part on the original expected policyholder pricing claims.

At the time of re-price or time of materially different pricing assumptions, the Cohort Ratio vector is applied to all in-force policies and locked in. In the event of additional future re-prices, future Cohort Ratios are cumulatively added for all in-force policies. When re-priced, new business is first priced and issued, and those policies will not have any Cohort Ratios until new business is re-priced again in the future.

In the event of an in-force rate increase, assumptions that were locked in at issue are unlocked and then re-locked using assumptions at time of the in force re-price. PPGs and optionally PPCs are also recalculated and any past Cohort Ratios will no longer be applied to the re-priced cohort (since that cohort's prices are being reset).

### Alternative Uses of Credits

It also should be noted that in certain alternative embodiments, excess returns may be shared with policyholders in ways other than offsetting premiums, such as, for example, providing a credit to the policyholder, providing a refund of premiums to the policyholder, providing a death benefit, placing credits or funds into an interest-bearing or other account to use for certain purposes (e.g., applying toward deductibles), automatically increasing plan benefits (e.g., purchasing additional coverage), purchasing riders, purchasing other insurance coverage (e.g., term life), or other ways of sharing. Thus, in certain embodiments of the present invention, credits are computed for the policyholders based on the Interest Credits and Insurance Credits, and these credits may be used to offset premiums or otherwise. Rather than EEC to be used each policy period, credits may be maintained cumulatively. The following pseudo-code would maintain a running count of the number of credits for a policyholder, where PEC may be the potential earnings credits as discussed above and PDB is the running count of credits:

| | |
|---|---|
| (1) | Determine ER for the plan period; |
| (2) | Determine policy gain/loss for the plan period; |
| (3) | For each policyholder |
| (4) | Determine ARV for the policyholder; |
| (5) | Determine Interest Credits based on ER and ARV (e.g., ER × ARV); |
| (6) | Determine Insurance Credits based on policy gain/loss; |
| (5) | PEC = Interest Credits + Insurance Credits; |
| (6) | PDBₜ = PDBₜ₋₁ + PEC; |
| (7) | Endfor |

Provisions may be made for accumulated credits to be used automatically and/or to be used at the discretion of the policyholder (e.g., the policyholder may allow the credits to accrue and then trigger the use of the credits). In various embodiments, the accumulated credits may or may not survive lapse of the policy (e.g., in some embodiments, accumulated credits may be forfeited, while in other embodiments, accumulated credits may be provided to the policyholder in one form or another (e.g., a refund)).

In one specific exemplary embodiment of an alternative use of excess returns, a policyholder's credits are accumulated from period-to-period in an accumulated credit account based on a predetermined formula. The accumulated credits are typically invested, with investment returns/losses applied to the accumulated credit account. The accumulated credits in the account (including any returns/losses, which may be subject to a guaranteed minimum return) may be used or otherwise provided to the policyholder or policyholder's estate at various times (and typically capped by actual premiums paid), such as at the time of a claim (e.g., to reimburse the policyholder for deductible expenses and thereafter to pay for qualified LTC expenses in excess of the policyholder's daily or monthly benefit, to pay for additional stay at home services); at policyholder death, when any remaining credits in the account may be liquidated (capped by actual premiums paid) and sent to the policyholder's estate; or at policy lapse, when any remaining credits in the account may be liquidated (capped by actual premiums paid) and sent to the policyholder although other LTC benefits are generally forfeited.

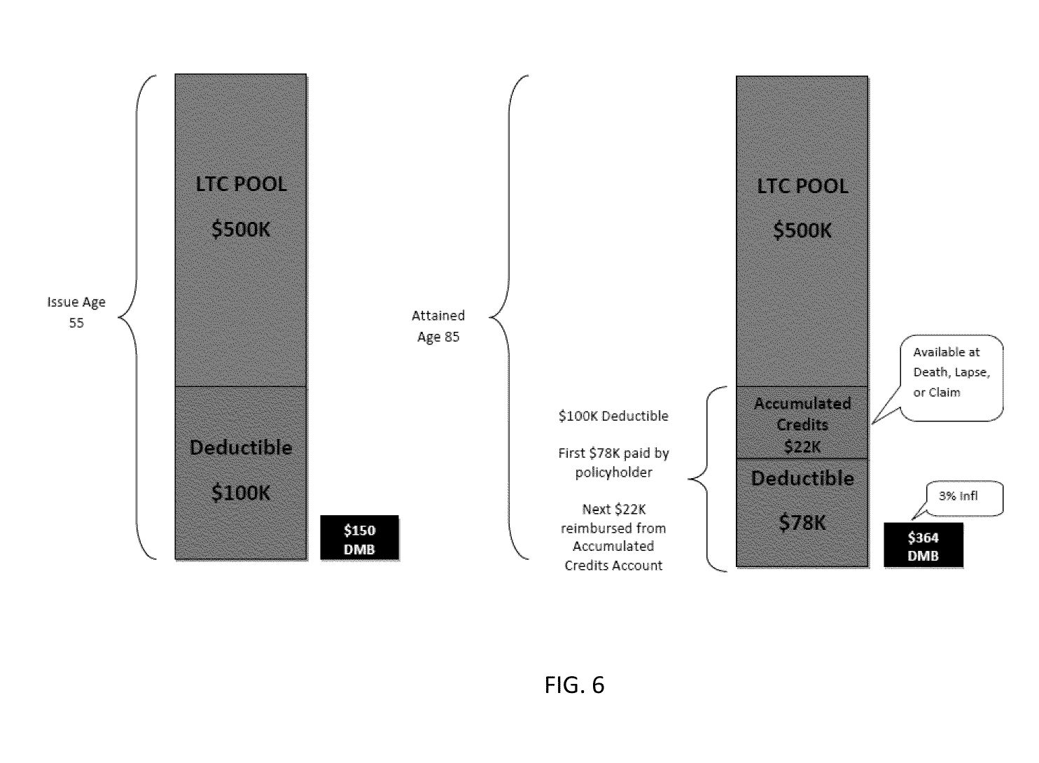

FIG. 6 is a schematic diagram showing how such an exemplary accumulated credit account feature might work in this one specific exemplary embodiment. In this purely hypothetical example, a policy having a $100,000 deductible and a $150 daily or monthly benefit (DMB) issued when the policyholder was 55 years old may have accumulated credits (including investment returns/losses) worth $22,000 when the policyholder attains the age of 85. Assuming the policyholder has a claim, then the policyholder would pay the first $78,000 of any deductible, and then the policyholder would be reimbursed for the next $22,000 of deductible. In this example, the policyholder's daily or month benefit has increased to $364 based on a fixed 3% inflation protection option. As discussed above, if the accumulated credits had been worth more than the deductible, then the policyholder would have been reimbursed the entire deductible, and the policyholder could use excess funds to pay for other qualified LTC expenses or the excess funds would be available upon death or policy lapse up to the amount of premiums paid.

Alternatively, as discussed above, credits may be used to automatically increase benefits for a policyholder. For example, if PEC is greater than zero, then PEC represents the potential number of earning credits that can be used in this one specific exemplary embodiment to increase benefits for the policyholder; this number is first used to reduce any deficit from prior plan periods, with any remaining credits (i.e., EEC) used to increase benefits. In one specific exemplary embodiment, the policyholder's PBI is determined based on the EEC and the SPR (e.g., PBI=EEC/SPR), and the policyholder's benefits are automatically increased based on the PBI. As but one example, purely to help demonstrate how PBI might work in the context of this specific exemplary embodiment, if EEC were determined to be $300.00 and the SPR for the policyholder was determined to be $100.00, then PBI might be $3.00, and the policyholder's LTC benefit (e.g., the policy daily or monthly benefit) might be increased by $3.00. In this one specific exemplary embodiment, when the LTC benefit amount is increased, the corresponding policy limit and other similar benefit amounts are increased as well. In this specific exemplary embodiment, the PBI has no cash value to the policyholder, i.e., the policyholder cannot get cash back or a reduced premium in lieu of the benefit increase. If ER (and therefore PEC) is less than zero, then PEC represents a deficit that in this one specific exemplary embodiment will be added to the policyholder's PDB, which will need to be made up before benefits will be increased for the policyholder in the future in plan periods that have positive ER.

### Miscellaneous

It should be noted that in various alternative embodiments, negative interest credits and negative insurance credits could be carried forward separately rather than being combined, interest credits and/or insurance credits could be floored at zero before being combined, negative credits could be carried forward for only a predetermined maximum number of years and then forgiven, funds/credits in an accumulation account could be offset with negative credits and/or negative credits could be carried forward with interest.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions. Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

It should be noted that headings are used above for convenience and are not to be construed as limiting the present invention in any way.

It should be noted that the term “processor” (e.g., used in the context of an LTC insurance policy processor) may be used herein to describe devices that may be used in certain embodiments of the present invention and should not be construed to limit the present invention to any particular device type unless the context otherwise requires. Thus, a device may include, without limitation, a bridge, router, bridge-router (brouter), switch, node, server, computer, appliance, or other type of device. Such devices typically include one or more network interfaces for communicating over a communication network and a processor (e.g., a microprocessor with memory and other peripherals and/or application-specific hardware) configured accordingly to perform device functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICS or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., the LTC insurance policy processors described herein) are necessarily non-conventional because, absent special programming or configuration, the conventional components do not inherently perform the described non-conventional methods.

The present invention may be embodied in other specific forms without departing from the true scope of the invention, and numerous variations and modifications will be apparent to those skilled in the art based on the teachings herein. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A long-term care insurance system for automatic crediting for a long-term care insurance policy, the long-term care insurance policy associated with a portfolio having a portfolio rate of return in a given plan period and/or gains/losses arising from insurance experience such as morbidity, mortality, and lapse, the system comprising:
a policyholder records storage;
a plan parameters storage; and
a LTC insurance policy processor coupled to the policyholder records storage and the plan parameters storage, the LTC insurance policy processor configured to determine an excess return based on the portfolio rate of return, automatically determine interest credits for a policyholder based on the excess return and information from the policyholder records storage and the plan parameters storage, automatically determine insurance credits for the policyholder based on apportioning previous period insurance gains or losses of the long-term care insurance policy, automatically determine potential earnings credits for the policyholder based on the determined interest credits and insurance credits, and automatically provide a benefit to the policyholder and update a policyholder record in the policyholder records storage based on the determined potential earnings credits.

2. A system according to claim 1, wherein determining the insurance credits comprises:
determining a total block actual gain for the policy; and
determining the insurance credits based on apportioning the total block actual gain to individual policyholders.

3. A system according to claim 1, further comprising:
automatically increasing long-term care benefits associated with the policyholder based on the potential earnings credits.

4. A system according to claim 1, wherein the benefit is provided when the number of potential earnings credits exceeds any deficit in credits associated with policyholder.

5. A system according to claim 1, wherein automatically providing the benefit comprises:
automatically providing the benefit based on the number of potential earnings credits less any deficit in credits associated with the policyholder.

6. A system according to claim 3, wherein automatically increasing benefits associated with the policyholder based on the number of potential earnings credits comprises:
determining a single premium rate for the policyholder; and
automatically increasing benefits associated with the policyholder based on the number of potential earnings credits and further based on the single premium rate determined for the policyholder.

7. A system according to claim 1, further comprising:
decreasing a deficit in credits associated with the policyholder based on the potential earnings credits when the number of potential earnings credits is less than any deficit in credits associated with the policyholder.

8. A system according to claim 1, further comprising:
increasing a deficit in credits associated with the policyholder based on the potential earnings credits when the number of potential earnings credits is negative.

9. A system according to claim 1, further comprising at least one of:
reducing premiums for the policyholder based on the potential earnings credits;
providing a credit to the policyholder based on the potential earnings credits; or
providing a refund to the policyholder based on the potential earnings credits.

10. A system according to claim 1, further comprising:
accumulating the credits in a policyholder accumulated credit account.

11. A system according to claim 10, wherein the accumulated credits in the accumulated credit account are invested, and wherein accumulating the credits in the policyholder accumulated credit account includes updating the accumulated credit account based on investment returns or losses.

12. A system according to claim 10, further comprising at least one of:
providing at least a portion of the accumulated credits for long term care expenses associated with a claim;
providing at least a portion of the accumulated credits for a death benefit; or
providing at least a portion of the accumulated credits as a refund.

13. Apparatus comprising a tangible, non-transitory computer-readable medium having embodied therein computer program instructions, which, when run on a processor, establishes processes for automatic crediting for a long-term care insurance policy, the long-term care insurance policy associated with a portfolio having a portfolio rate of return in a given plan period and/or gains/losses arising from insurance experience such as morbidity, mortality, and lapse, the processes comprising:
a first computer process in which an excess return is determined based on the portfolio rate of return;
a second computer process in which interest credits for a policyholder are automatically determined based on the excess return, wherein automatically determining credits for the policyholder comprises:
determining a notional or actual allocated reserve value for the policyholder; and
automatically determining interest credits based on the excess return and the determined allocated reserve value;
a third computer process in which insurance credits for the policyholder are automatically determined based on previous period gains or losses of the long-term care insurance policy and apportioned to individual policyholders;
a fourth computer process in which potential earnings credits for the policyholder are automatically determined based on the determined interest credits and insurance credits; and
a fifth computer process in which a benefit is automatically provided to the policyholder and a policyholder record maintained in a tangible non-transitory computer-readable storage is automatically updated based on the determined potential earnings credits.

14. Apparatus according to claim 13, wherein determining insurance credits comprises:
determining a total block actual gain for the policy; and
determining the insurance credits based on apportioning the total block actual gain to individual policyholders.

15. Apparatus according to claim 13, further comprising:
automatically increasing long-term care benefits associated with the policyholder based on the potential earnings credits.

16. Apparatus according to claim 13, wherein the benefit is provided when the number of potential earnings credits exceeds any deficit in credits associated with policyholder.

17. Apparatus according to claim 13, wherein automatically providing the benefit comprises:
automatically providing the benefit based on the number of potential earnings credits less any deficit in credits associated with the policyholder.

18. Apparatus according to claim 15, wherein automatically increasing benefits associated with the policyholder based on the number of potential earnings credits comprises:
determining a single premium rate for the policyholder; and
automatically increasing benefits associated with the policyholder based on the number of potential earnings credits and further based on the single premium rate determined for the policyholder.

19. Apparatus according to claim 13, further comprising:
decreasing a deficit in credits associated with the policyholder based on the potential earnings credits when the number of potential earnings credits is less than any deficit in credits associated with the policyholder.

20. Apparatus according to claim 13, further comprising:
increasing a deficit in credits associated with the policyholder based on the potential earnings credits when the number of potential earnings credits is negative.

21. Apparatus according to claim 13, further comprising at least one of:
reducing premiums for the policyholder based on the potential earnings credits;
providing a credit to the policyholder based on the potential earnings credits; or
providing a refund to the policyholder based on the potential earnings credits.

22. Apparatus according to claim 13, further comprising:
accumulating the credits in a policyholder accumulated credit account.

23. Apparatus according to claim 22, wherein the accumulated credits in the accumulated credit account are invested, and wherein accumulating the credits in the policyholder accumulated credit account includes updating the accumulated credit account based on investment returns or losses.

24. Apparatus according to claim 22, further comprising at least one of:
providing at least a portion of the accumulated credits for long term care expenses associated with a claim;
providing at least a portion of the accumulated credits for a death benefit; or
providing at least a portion of the accumulated credits as a refund.
